(19) United States
(12) Patent Application Publication
(10) Pub. No.: US 2003/0175522 A1
(43) Pub. Date: Sep. 18, 2003

(54) Poly(trimethylene terephthalate) carpets

(76) Inventors: Joseph Varapadavil Kurian, Newark, DE (US); Justine Gabrielle Franchina, Hockessin, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/099,373

(22) Filed: Mar. 13, 2002

(51) Int. Cl. B05D 3/02; B32B 27/00

(52) U.S. Cl. 428/421; 428/422; 427/389.9; 427/393.4

(57) ABSTRACT

A treated poly(trimethylene terephthalate) carpet prepared by a process comprising applying a fluoropolymer emulsion to a poly(trimethylene terephthalate) carpet and curing the fluoropolymer at a temperature of about 250 to about 310° F., the treated poly(trimethylene terephthalate) carpet having an oil repellency rating of at least 4. In addition, a process of preparing the treated poly(trimethylene terephthalate) carpet.

### FIELD OF THE INVENTION

This invention relates to poly(trimethylene terephthalate) carpets, and manufacture and use thereof.

### BACKGROUND OF THE INVENTION

U.S. Pat. Nos. 5,645,782 Howell et al., 6,109,015 Roark et al. and 6,113,825 Chuah; WO 99/19557 Scott et al.; H. Modlich, “Experience with Polyesters Fibers in Tufted Articles of Heat-Set Yarns, Chemiefasern/Textilind. 41/93, 786-94 (1991); and H. Chuah, “Corterra Poly(trimethylene terephthalate)—New Polymeric Fiber for Carpets”, The Textile Institute Tifcon '96 (1996) (available at http://www.shellchemicals.com/corterra/0,1098,281,00.html), all of which are incorporated herein by reference, describe carpets made with poly(trimethylene terephthalate) (“3GT”) fibers. Poly(trimethylene terephthalate) is disperse dyeable at atmospheric pressure, is easily pigmented and has low bending modulus, making it excellent for use in carpets. Poly(trimethylene terephthalate) carpets have good elastic recovery and resilience, and are resistant to most aqueous stains, such as coffee, cola, ink, mustard, grape juice, ketchup, etc. However, poly(trimethylene terephthalate) carpets are readily stained by oily materials such as motor oil and corn oil.

U.S. Pat. No. 6,109,015 Roark et al. describes that the spin finish used to improve yarn performance and spinning may include functional additives, such as stain resistance additives and anti-soiling additives, including fluorochemicals. It does not disclose which fluorochemical are suitable for this use and makes no mention of carpet treatments.

There is a need for poly(trimethylene terephthalate) carpets that are not readily stained by oily materials such as motor oil, corn oil, shoe polish, and other hydrocarbon oils and waxes. The present invention provides such carpets and a method for treating poly(trimethylene terephthalate) carpets so that they are not readily stained by oily materials.

### SUMMARY OF THE INVENTION

The invention is directed to a treated poly(trimethylene terephthalate) carpet prepared by a process comprising applying a fluoropolymer emulsion to a poly(trimethylene terephthalate) carpet and curing the fluoropolymer at a temperature of about 250 to about 310° F., the treated poly(trimethylene terephthalate) carpet having an oil repellency rating of at least 4.

The invention is also directed to a treated poly(trimethylene terephthalate) carpet prepared by a process comprising applying a fluoropolymer emulsion to a poly(trimethylene terephthalate) carpet and curing the fluoropolymer at a temperature of about 250 to about 310° F., the treated poly(trimethylene terephthalate) carpet having an oil repellency rating of at least 4, wherein the fluoropolymer emulsion is prepared by emulsion polymerization of the following monomers in the following weight percentages, based on the total weight of the fluoropolymer:

(a) from about 40% to about 75% of a monomer of formula I:

R_{f}—CH₂CH₂—OC(O)—C(R)═CH₂ (I)

(b) from about 15% to about 55% of a monomer of formula II:

R₂—OC(O)—C(R)═CH₂ (II)

(c) from about 0.5% to about 5% of a monomer of the formula III

HO—CH₂CH₂—OC(O)—C(R)═CH₂ (III)

(d) from about 1.5% to about 5% of a monomer of the formula IV:

H—(OCH₂CH₂)ₘ—O—C(O)—C(R)═CH₂ (IV)

(e) from about 1% to about 3% of a monomer of the formula V:

HO—CH₂—NH—C(O)—C(R)═CH₂ (V)

(f) from 0% up to about 20% of vinylidene chloride (formula VI) or vinyl acetate (formula VII), or a mixture thereof:

CH₂═CCl₂ (VI)

CH₃—(O)COCH═CH₂ (VII),

wherein R_{f} is a straight or branched-chain perfluoroalkyl group of from 2 to about 20 carbon atoms, each R is independently H or CH₃; R₂ is an alkyl chain from 2 to about 18 carbon atoms; and m is 2 to about 10.

The invention is also directed to process of preparing the treated poly(trimethylene terephthalate) carpet comprising (a) applying the fluoropolymer emulsion to the poly(trimethylene terephthalate) carpet and curing the fluoropolymer at a temperature of about 250 to about 310° F., the treated poly(trimethylene terephthalate) carpet having an oil repellency rating of at least 4. Preferably the fluoropolymer emulsion is an aqueous emulsion comprising 15-35 weight %, by weight of the emulsion, of the fluoropolymer.

Curing is preferably carried out at least about 260° F. (127° C.), more preferably at least about 270° F. (132° C.) and most preferably at least about 280° F. (138° C.), and preferably up to about 305° F. (152° C.), more preferably up to about 300° F. (150° C.). Curing is preferably carried out for at least about 30 seconds, preferably at least about 1 minute, and up to about 10 minutes, preferably up to about 5 minutes, more preferably up to about 3 minutes, and most preferably up to about 180 seconds.

The treated poly(trimethylene terephthalate) carpet of claim 1 having a water repellency rating of at least 6.

The treated poly(trimethylene terephthalate) carpet preferably has an oil repellency rating of at least 5, even more preferably at least 6.

The treated poly(trimethylene terephthalate) carpet preferably has a water repellency rating of at least 6, preferably at least 7, and even more preferably of 8.

The treated poly(trimethylene terephthalate) carpet preferably has a stain repellency rating of at least 2, preferably of 1. In addition, the staining rating is preferably at least slight (SLS), more preferably none (NS).

The treated poly(trimethylene terephthalate) carpet preferably has a yellowing rating of at least 3, preferably at least 2 and more preferably 1.

In one preferred embodiment, the fluoropolymer emulsion is made by polymerizing the monomers (I)-(VII) in the following percentages by weight:

(a) from about 40% to about 65% of the monomer of formula (I);

(b) from about 15% to about 50% of the monomer of formula (II);

(c) from about 1.5% to about 5% of the monomer of formula (III);

(d) from about 1.5% to about 5% of the monomer of formula (IV);

(e) from about 1.5% to about 3% of the monomer of formula (V); and

from 0% up to about 20% of the monomer of formula (VI) and/or (VI).

In another preferred embodiment, the fluoropolymer emulsion is made by polymerizing the monomers (I)-(VII) in the following percentages by weight:

(a) from about 40% to about 50% of the monomer of formula (I);

(b) from about 40% to about 50% of the monomer of formula (I);

(c) from about 4% to about 5% of the monomer of formula (III);

(d) from about 4% to about 5% of the monomer of formula (IV);

(e) from about 1.5% to about 3% of the monomer of formula (V); and

(f) from 0% up to about 10% of the monomer of formula (VI) and/or (VII).

In one preferred embodiment, the fluoropolymer emulsion is made with little (e.g., less than 1 wt %) or no vinylidene chloride. In another preferred embodiment, the fluoropolymer emulsion is preferably made with little (e.g., less than 1 wt %) or no vinylidene chloride and vinyl acetate.

In yet another preferred embodiment, The treated poly(trimethylene terephthalate) carpet of claim 1 wherein the fluoropolymer emulsion is made by polymerizing the monomers (I)-(VII) in the following percentages by weight:

(a) from about 55% to about 65% of the monomer of formula (I);

(b) from about 15% to about 25% of the monomer of formula (II);

(c) from about 1.5% to about 5% of the monomer of formula (III);

(d) from about 1.5% to about 5% of the monomer of formula (IV);

(e) from about 1.5% to about 3% of the monomer of formula (V); and

(f) from about 10% up to about 20% of the monomer of formula (VI) and/or (VII).

Preferably R_{f} in monomer (a) of formula I is: CF₃CF₂(CF₂)ₓC₂H₄OC(O)—C(H)═CH₂, wherein x=6-18.

Preferably monomer (b) is one or a mixture of alkyl (meth)acrylates having chain lengths of 12 to 18 carbons.

Preferably monomer (c) is hydroxyethyl methacrylate.

Preferably for monomer (d), m is between about 5 and about 10.

Preferably monomer (e) is N-methylol acrylamide or methacrylamide.

Preferably the treated poly(trimethylene terephthalate) carpet has a fluorine content of from about 0.05% to about 0.5% weight %, by weight of the face fibers.

In one preferred embodiment, the poly(trimethylene terephthalate) carpet contains at least 70 weight %, by weight of face fibers of the carpet, of tufted poly(trimethylene terephthalate) bulked continuous filament or poly(trimethylene terephthalate) staple fiber yarn, the poly(trimethylene terephthalate) containing at least about 70 mole % or more of poly(trimethylene terephthalate). Preferably at least 98 weight %, by weight of the face fibers of the poly(trimethylene terephthalate) carpet, are the tufted poly(trimethylene terephthalate) bulked continuous filament. Preferably the poly(trimethylene terephthalate) contains at least about 90 mole % or more of poly(trimethylene terephthalate).

### DETAILED DESCRIPTION OF THE INVENTION

In all instances herein, the term “(meth)acrylate” is used to denote either acrylate or methacrylate, or mixtures thereof.

By “carpet” reference is made to floor coverings for commercial or residential use, such as rugs or carpet tiles, comprising, as face fibers (i.e., fibers on the top or visible surface), tufted bulked continuous filament (“BCF”) yarns, tufted yarn comprising staple fibers, or woven yarn.

By “poly(trimethylene terephthalate) carpet” reference is made to any carpet comprising poly(trimethylene terephthalate) face fibers. Such carpets can contain other fibers, such as nylon, wool, polyolefins, polylactic acid, other polyester fibers (e.g., poly(ethylene terephthalate fibers), etc. They preferably contain at least 50 weight %, more preferably at least 60 weight %, even more preferably at least 70, 80, 90, 95 or 98 weight %, and up to 100 weight %, by weight of the face fibers, of poly(trimethylene terephthalate) fibers.

By “poly(trimethylene terephthalate) fibers” reference is made to poly(trimethylene terephthalate) monocomponent and multicomponent (e.g., sheath/core or side-by-side bicomponent fibers, such as poly(trimethylene terephthalate)/poly(ethylene terephthalate) sheath/core or side-by-side bicomponent) fibers). Carpet fibers are preferably monocomponent fibers.

Poly(trimethylene terephthalate)s fibers useful in this invention are well known. By “poly(trimethylene terephthalate)”, reference is made to compositions comprising poly(trimethylene terephthalate) homopolymer and copolymers, by themselves or in blends.

The poly(trimethylene terephthalate) of the invention preferably contains about 70 mole % or more, preferably at least 90 mole %, of poly(trimethylene terephthalate). It may be polymerized with up to 30 mole % of polyester repeat units made from other diols or diacids. The other diacids include isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. The other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides. Polymers useful in this invention also include polymeric compositions and polymers comprising functional additive(s) or monomer(s). The poly(trimethylene terephthalate) of the invention more preferably contains more than 70 mole % poly(trimethylene terephthalate), i.e., more preferably at least 80, 90, 95 and 99 mole %. The most preferred polymer is poly(trimethylene terephthalate) homopolymer.

The poly(trimethylene terephthalate) of the invention may be blended with other polymers such as poly(ethylene terephthalate), nylon 6, nylon 6,6, poly(butylene terephthalate), etc., and preferably contains 70 mole % or more poly(trimethylene terephthalate), more preferably at least 80, 90, 95 and 99 mole % poly(trimethylene terephthalate). Most preferred is use of poly(trimethylene terephthalate) without such other polymers.

Poly(trimethylene terephthalate) has an intrinsic viscosity that typically is about 0.5 deciliters/gram (dl/g) or higher, and typically is about 2 dl/g or less. The poly(trimethylene terephthalate) preferably has an intrinsic viscosity that is about 0.7 dl/g or higher, more preferably 0.8 dl/g or higher, even more preferably 0.9 dl/g or higher, and typically it is about 1.5 dl/g or less, preferably 1.4 dl/g or less, and commercial products presently available have intrinsic viscosities of 1.2 dl/g or less. Poly(trimethylene terephthalates) useful as the polymer of this invention are commercially available from E. I. du Pont de Nemours and Company, Wilmington, Del. under the trademark “Sorona”.

Carpets made with poly(trimethylene terephthalate) fibers and manufacture thereof, as well as the fibers and manufacture of the fibers, are described in U.S. Pat. Nos. 5,645,782 Howell et al., 6,109,015 Roark et al. and 6,113,825 Chuah; U.S. patent application Ser. Nos. 09/895,906, 09/708,209 and 09/938,760 (Attorney Docket Nos. CH2783, RD7850 and CH2800, respectively); WO 99/19557 Scott et al.; H. Modlich, “Experience with Polyesters Fibers in Tufted Articles of Heat-Set Yarns, Chemiefasern/Textilind. 41/93, 786-94 (1991); and H. Chuah, “Corterra Poly(trimethylene terephthalate)—New Polymeric Fiber for Carpets”, The Textile Institute Tifcon '96 (1996), all of which are incorporated herein by reference. Staple fibers are primarily used to prepare residential carpets. BCF yams are used to prepare all types of carpets and are usually preferred for carpets.

The fibers can contain various additives, e.g., antioxidants, delusterants (e.g., TiO₂, zinc sulfide or zinc oxide), colorants (e.g., dyes or pigments), stabilizers, flame retardants, fillers (such as calcium carbonate), antimicrobial agents, antistatic agents, optical brightners, toners, extenders, processing aids, viscosity boosters, and other functional additives. Pigments are commonly added to carpet fibers and one preferred method of adding pigment is described in U.S. patent application Ser. No. 09/895,906 (Attorney Docket No. CH2783), which is incorporated herein by reference.

The carpets or fibers can be dyed using disperse, acid, basic or other dyes. Acid dyeable polymer compositions and fibers suitable for use in this invention are described in U.S. patent application Ser. Nos. 09/708,209 and 09/938,760 (Attorney Docket Nos. RD7850 and CH2800), and WO 01/34693, all of which are incorporated herein by reference. Basic dyeable polyester compositions suitable for use in this invention include those described in U.S. Pat. No. 6,312,805 Sun.

Many fluoropolymers used to treat carpets and fabrics cure at a temperature of about 330° F. or higher under commercial manufacturing conditions. The inventors discovered that selection of a fluoropolymer emulsion that results in fluoropolymer cure at temperatures below about 310° F. is significantly better for manufacture of poly(trimethylene terephthalate) carpet and that the amount of crosslinking agent (e.g., monomers (c), (d) and (e)), surfactants, solvents or other additives (e.g., blocked isocyanates) and the ratios thereof impact cure temperature. Thus, the fluoropolymer emulsion of this invention is curable on a poly(trimethylene terephthalate) carpet in the temperature ranges specified herein when cured for the time periods specified herein. If the fluoropolymer cures, an increase in oil repellency should result. Thus, whether a fluoropolymer emulsion results in curing in the above range can be evaluated by preparing a carpet sample and testing it as described herein. If the oil repellency rating is above 4, and the oil repellency rating increased as compared to a control without the fluoropolymer, when heated at any temperature within the range of about 250° F. (121° C.) to about 310° F. (155° C.) for any time period within the range of about 30 seconds to about 10 minutes, then the fluoropolymer emulsion is suitable.

The preferred fluoropolymers are prepared by emulsion polymerization of the following monomers in the following percentages by weight, relative to the total weight of the fluoropolymer.

(a) from about 40% to about 75% of a monomer of formula I:

R_{f}—CH₂CH₂—OC(O)—C(R)═CH₂ (I)

(b) from about 15% to about 55% of a monomer of formula II:

R₂—OC(O)—C(R)═CH₂ (II)

(c) from about 0.5% to about 5% of a monomer of the formula III

HO—CH₂CH₂—OC(O)—C (R)═CH₂ (III)

(d) from about 1.5% to about 5% of a monomer of the formula IV:

H—(OCH₂CH₂)ₘ—O—C(O)—C(R)═CH₂ (IV)

(e) from about 1% to about 3% of a monomer of the formula V:

HO—CH₂—NH—C(O)—C(R)═CH₂ (V)

wherein R_{f} is a straight or branched-chain perfluoroalkyl group of from 2 to about 20 carbon atoms, each R is independently H or CH₃; R₂ is an alkyl chain from 2 to about 18 carbon atoms; and m is 2 to about 10.

Optionally, the fluoropolymer may further be prepared from monomer (f) in an amount from 0% up to about 20% of vinylidene chloride (formula VI) or vinyl acetate (formula VII), or a mixture thereof:

CH₂═CCl₂ (VI)

CH₃—(O)COCH═CH₂ (VII)

These ranges are preferred for the best durability of oil-, water- and soil repellent properties. The monomers are combined in proportion within their designated ranges to add up to 100% by weight.

The person of ordinary skill in the art will readily recognize that by reference to an amount of a monomer of a specified formula, it is meant that the fluoropolymer can be prepared with one or more monomers of that formula as long as the total weight % of those monomers is within the specified range.

In a preferred embodiment, the fluoropolymer emulsion is made by polymerizing monomers (I)-(VII) in the following percentages by weight:

(a) from about 40% to about 65% of the monomer of formula (I);

(b) from about 15% to about 50% of the monomer of formula (II);

(c) from about 1.5% to about 5% of the monomer of formula (III);

(d) from about 1.5% to about 5% of the monomer of formula (IV);

(e) from about 1.5% to about 3% of the monomer of formula (V); and

(f) from 0% up to about 20% of the monomer of formula (VI) and/or (VII).

In the most preferred embodiment, which is particularly useful where yellowing due to the inclusion of a large amount of vinylidene chloride or other vinyl monomers may be a problem, the fluoropolymer emulsion is made by polymerizing monomers (I)-(VII) in the following percentages by weight:

(a) from about 40% to about 50% of the monomer of formula (I);

(b) from about 40% to about 50% of the monomer of formula (II);

(c) from about 4% to about 5% of the monomer of formula (III);

(d) from about 4% to about 5% of the monomer of formula (IV);

(e) from about 1.5% to about 3% of the monomer of formula (V); and

(f) from 0% up to about 10% of the monomer of formula (VI) and/or (VII).

In a more preferred embodiment, the fluoropolymer is prepared without vinylidene chloride. In another more preferred embodiment, the fluoropolymer is prepared without vinylidene chloride or vinyl acetate.

In an alternative preferred embodiment, the fluoropolymer emulsion is made by polymerizing monomers (I)-(VII) in the following percentages by weight:

(a) from about 55% to about 65% of the monomer of formula (I);

(b) from about 15% to about 25% of the monomer of formula (II);

(c) from about 1.5% to about 5% of the monomer of formula (III);

(d) from about 1.5% to about 5% of the monomer of formula (IV);

(e) from about 1.5% to about 3% of the monomer of formula (V); and

(f) from about 10% up to about 20% of the monomer of formula (VI) and/or (VII).

Preferably R_{f} in monomer (a) of formula I is: CF₃CF₂(CF₂)ₓC₂H₄OC(O)—C(H)═CH₂, wherein x=6-18. More preferably monomer (a) of formula I is a perfluoroalkylethyl acrylate with a perfluoroalkyl carbon chain length distribution by weight of about 50% of 8-carbon, about 30% of 10-carbon, about 10% of 12-carbon, and with smaller percentages of 6-carbon and 14-carbon and longer chain lengths. If it is present in amounts lower than about 40% of the monomer of formula (all monomer weights are given relative to the total weight of fluoropolymer), the fluoropolymer becomes more hydrophilic and the oil- and water-repellency drops off to an undesirable level. If it is present in amounts higher than about 75%, the fluoropolymer is no longer cost effective.

The required monomer (b) of formula 11 in the present invention is one or a mixture of alkyl (meth)acrylates having chain lengths of 2 to 18 carbons, preferably 12 to 18 carbons.

As used herein, “alkyl” refers to linear, branched-chain and cyclic alkyl groups. Examples of such monomers include ethyl acrylate, propyl acrylate, butyl acrylate, cyclohexyl acrylate, stearyl acrylate, lauryl acrylate, stearyl methacrylate, lauryl methacrylate, 2-ethylhexyl acrylate, and isodecyl acrylate. Of the foregoing, stearyl acrylate and stearyl methacrylate are most preferred.

It has found that by incorporating the three monomers (c), (d) and (e) of formulas II, IV and V into the fluoropolymer, the amount of vinylidene chloride can be sharply decreased or eliminated while achieving comparable repellency and durability. The proportion of each of these monomers employed determines the softness of the product, the performance of the product, and the durability of the repellency properties.

Monomer (c) is a hydroxyethyl (meth)acrylate. Preferably it is hydroxyethyl methacrylate (HEMA). The percentage by weight of monomer (c) must be at least about 0.5%, by weight of the fluoropolymer to provide the necessary durability and performance attributes. Preferably it is above about 1.5%. To avoid adverse effects the amount of monomer (c) should be below about 5%.

Monomer (d) is an ethoxylated (meth)acrylate wherein the number of ethoxy groups is between 2 and 10. Between 5 and 10 ethoxy groups are preferred. The percentage by weight of monomer (d) must be at least about 1.5% to provide the necessary durability and performance attributes. To avoid adverse effects the amount of monomer (d) should be below about 5%.

Monomer (e) is N-methylol acrylamide or methacrylamide. N-methylol acrylamide (MAM) is preferred. The percentage by weight of monomer (e) must be at least about 1% to provide the necessary durability and performance attributes. Preferably it is above about 1.5%. To avoid adverse effects the amount of monomer (e) should be below about 3%.

The utility of incorporating these three monomers (c), (d) and (e) into the fluoropolymer backbone is the efficient cross-linking between the various polymer chains upon cure.

One of the major advantages of the inventive composition is its flexibility for a variety of uses. Its hydrophobic and oleophobic properties on a wide range of carpets can be varied for different applications by simply varying the relative amounts of monomers (a) (b) (c) (d) and (e), while still maintaining its properties as a durable repellent.

Optionally, the fluoropolymer can also contain up to about 20% by weight of monomer (f), i.e., vinylidene chloride or vinyl acetate, or a mixture thereof. The addition of a relatively small amount of vinylidene chloride or vinyl acetate may be desirable to improve the compatibility of the fluoropolymer with the carpet, or to reduce overall costs. The amount of monomer (f) should be below about 20% by weight to avoid possible yellowing of the carpet.

The fluoropolymers are prepared by conventional emulsion polymerization techniques. The surfactant(s) employed to stabilize the emulsion during its formation and during polymerization can be a cationic or non-ionic emulsifying agent or agents (such as alkyl ethoxylates), and the surfactant(s), solvent(s) and other additives can impact the cure temperature. The polymerization is conveniently initiated by azo initiators such as 2,2′-azobis(2-amidinopropane)dihydrochloride. These initiators are sold by E. I. du Pont de Nemours and Company, Wilmington, Del., commercially under the name of “VAZO”, and by Wako Pure Industries, Ltd., Richmond, Va., under the name “V-50.”

Compositions useful in this invention are described in U.S. Pat. No. 4,742,140 and co-pending U.S. patent application Ser. No. ______, filed Mar. 4, 2002 (continuation-in-part of U.S. patent application Ser. No. 09/855,395, filed May 15, 2001) (Attorney Docket No. CH-2803 CIP), both of which are incorporated herein by reference. One compound useful for practicing this invention, Zonyl® 7040, is available from E. I. du Pont de Nemours and Company, Wilmington, Del.

The fluoropolymer emulsion is preferably an aqueous emulsion comprising 15-35 weight %, by weight of the emulsion, of the fluoropolymer.

The carpets are prepared by applying the fluoropolymer emulsion to the carpet and curing the fluoropolymer. The fluoropolymer emulsion is applied to carpets by known methods to impart oil-, soil- and water-repellency. The fluoropolymer emulsion can be applied to the carpet in the form of a dispersion in water or other solvents (such as hexylene glycol, acetone, tripropylene glycol, dipropylene glycol, etc.), either before, after, or during the application of other carpet treatment chemicals (e.g., in a mixture with the other treatment chemicals). The dispersion can be applied as a foam, or by dipping or spraying, or by other methods. After excess liquid has been removed, for example by squeeze rolls, the treated carpet is dried and then cured by heating.

Curing is carried out in the range of about 250° F. (121° C.) to about 310° F. (155° C.), preferably at least about 260° F. (127° C.), more preferably at least about 270° F. (132° C.) and most preferably at least about 280° F. (138° C.) and preferably up to about 305° F. (152° C.), more preferably up to about 300° F. (150° C.), for at least about 30 seconds, preferably at least about 1 minute, and up to about 10 minutes, preferably up to about 5 minutes, more preferably up to about 3 minutes, and most preferably up to about 180 seconds. Such curing enhances oil-, water- and soil repellency and durability of the repellency.

The fluoropolymer emulsion is applied to the carpet in an amount effective to increase the carpets oil repellency. Preferably, it is added in an amount also effective to increase the carpets water repellency. The treated carpet preferably has a fluorine content of from about 0.05% to about 0.5% weight %, by weight of the face fibers, as obtained by fluorine analysis using the Wickbold Torch Method (Wickbold Torch Method W8000.205.02.CW, available from E. I. du Pont de Nemours and Company, Chambers Works, Deepwater, N.J.)

The fluoropolymers and method of the present invention are useful to enhance oil-, water- and soil-repellency of poly(trimethylene terephthalate) carpets even after repeated cleaning. The treated carpet has superior oil- and water-repellencies, especially in terms of durability after cleaning. The preferred embodiment also provides low yellowing.

Carpet oil repellency can be measured by a modification of AATCC standard Test Method No. 118, conducted described below. The treated carpets of this invention achieve an oil repellency rating of at least 4, preferably at least 5, and even more preferably at least 6, according to this test.

Water repellency is measured according to the DuPont Technical Laboratory Method as outlined in the DuPont® Teflon® “Global Specifications and Quality Control Tests for Fabrics Treated with Teflon” Product Information packet (Revised February 2001), as described below. The treated carpets of this invention achieve an oil repellency rating of at least 6, preferably at least 7, and even more preferably of 8, according to this test.

Stain repellency is measured by a modification of AATCC standard Test Method No. 118, conducted as described below. In corn oil tests, the treated carpets of this invention achieve a rating of at least 2, preferably of 1. In motor oil tests, the carpets of this invention achieve a rating of at least 2, preferably of 1. In addition, the staining rating is at least slight (SLS) and preferably none (NS).

Yellowing of a treated carpet upon cure is measured using a DuPont Technical Laboratory Method as described below. In a preferred embodiment of the invention, the treated carpet obtains a rating of at least 3, preferably at least 2 and more preferably 1.

The invention is demonstrated in the following examples, which are not intended to be limiting. Therein, all percentages, parts, etc., are by weight unless otherwise indicated.

### EXAMPLES

Test Methods

The following tests were employed in evaluating the examples herein.

Carpet Treatment

A bath was prepared by adding 1.5 weight %, by weight of the bath, of an aqueous fluoropolymer emulsion (the 1.5 weight % was measured using the total weight of the emulsion) and 0.2 weight %, by weight of the bath, of a wetting agent (Alkanol® 6112 (E. I. du Pont de Nemours and Company, Wilmington, Del.)). The face fibers of the carpet tested were poly(trimethylene terephthalate) (“3GT”) bulked continuous filaments (“BCF”) and this carpet is referred to as “3GT carpet” or “carpet” in the remained of the examples. The carpet was either submerged in the treatment bath to 100% wet pickup or the bath was sprayed on the surface of the carpet to obtain 100% wet pickup, with comparable results.

The carpet was dried at 100° C. for 30 minutes and then cured at 280° F. (138° C.) and/or 300° F. (150° C.) for 2-3 minutes. The carpet was allowed to “rest”, i.e., to come to ambient temperature over a period of two hours after treatment and cure.

Water Repellency

The water repellency of a substrate (carpet) was measured according to the DuPont Technical Laboratory Method as outlined in the DuPont® Teflon® “Global Specifications and Quality Control Tests for Fabrics Treated with Teflon” Product Information packet (Revised February 2001). The test determines the resistance of a substrate to wetting by aqueous liquids. Drops of water-alcohol mixtures of varying surface tensions were placed on the substrate and the extent of surface wetting was determined visually. The test provides a rough index of aqueous substance. The higher the water repellency rating, the better the resistance of a substrate to staining by water-based substances. The composition of standard test liquids is shown in the following table.

TABLE 1
Standard Test Liquids

| Water | | |
|---|---|---|
| Repellency | Composition, Vol % | |
| Rating Number | Isopropyl Alcohol | Distilled Water |
| 1 | 2 | 98 |
| 2 | 5 | 95 |
| 3 | 10 | 90 |
| 4 | 20 | 80 |
| 5 | 30 | 70 |
| 6 | 40 | 60 |
| 7 | 50 | 50 |
| 8 | 60 | 40 |

Oil Repellency

The substrate (carpet) samples were tested for oil repellency by a modification of AATCC standard Test Method No. 118, conducted as follows. A substrate sample was conditioned for a minimum of 2 hours at 23° C.+20% relative humidity and 65° C.+10% relative humidity. A series of organic liquids, identified below in Table 2, were then applied dropwise to the substrate samples. Beginning with the lowest numbered test liquid (Repellency Rating No. 1), one drop (approximately 5 mm in diameter or 0.05 mL volume) was placed on each of three locations at least 5 mm apart. The drops were observed for 30 seconds. If, at the end of this period, two of the three drops were still spherical in shape with no wicking around the drops, three drops of the next highest numbered liquid were placed on adjacent sites and similarly observed for 30 seconds. The procedure was continued until one of the test liquids results in two of the three drops failing to remain spherical to hemispherical, or wetting or wicking occurs.

The oil repellency rating of the substrate (carpet) was the highest numbered test liquid for which two of the three drops remained spherical to hemispherical, with no wicking for 30 seconds. In general, substrates with a rating of 5 or more are considered good to excellent; substrates having a rating of one or greater can be used in certain applications.

TABLE 2
Oil Repellency Test Liquids

| Oil Repellency | |
|---|---|
| Rating Number | Test Solution |
| 1 | Kaydol ® Purified Mineral Oil* |
| 2 | 65/35 Kaydol/n-hexadecane by volume at 21° C. |
| 3 | n-hexadecane |
| 5 | n-dodecane |
| 6 | n-decane |

*Kaydol is a trademark of Witco (Greenwich, CT), for a mineral oil having a Saybolt viscosity of 360/390 at 38° C. and a specific gravity of 0.880/0.900 at 1500.

Stain Repellency

The substrate (carpet) samples were tested for stain repellency by a modification of AATCC standard Test Method No. 118, conducted as follows. The substrate sample was conditioned for a minimum of 2 hours at 23° C.+20% relative humidity and 65° C.+10% relative humidity. Corn oil and motor oil were then applied dropwise to the substrate samples. One drop (approximately 5 mm in diameter or 0.05 mL volume) was placed on each of three locations at least 5 mm apart. The drops were observed for 30 seconds. If, at the end of this period, two of the three drops were still spherical in shape with no wicking around the drops, the substrate was given a rating of 1, if the drop was rounded and then there was slight spreading of the oil drop then the rating given was a 2, if the drop was flat initially the rating given was a 3, if the drop was flat and soaks in after 20 seconds a rating of 4 was given, if the drop soaks in immediately a rating of 5 was given. The drops of oil were then removed from the surface; if a stain remains the substrate has good oil repellency, but poor stain repellency. If no stain remains then the substrate has good oil and stain repellency. Staining was designated as none (NS), slight (SLS) and severe (SS).

Yellowing of Carpet:

The yellowing of a carpet upon cure was measured according to a DuPont Technical Laboratory Method. A 1 inch by 1 inch piece of carpet was submerged into a neat solution of the product, removed and wrung out. The piece of carpet was then laid on a screen and cured in the oven at 180° C. for 2-5 minutes. As a control, a piece of carpet was submerged in water and cured at 180° C. The rating of the yellowing was done visually, the samples were compared and rated against themselves and the untreated cured carpet. A piece that does not yellow was rated as a 1; a piece that yellows slightly was rated as a 2-4; a piece that yellows and becomes slightly tan was rated as a 5-6; a piece that becomes yellow brown was rated as a 7-8; and finally a piece that becomes brown was rated as a 9-10.

### Example 1

A polyfluoroacrylate emulsion useful in the invention was prepared as follows.

A four-necked flask fitted with a stirrer, thermocouple thermometer, and a dry ice condenser was charged with (a) 60 g (44 parts by weight) of a fluoromonomer having the formula:

CF₃CF₂(CF₂)ₓC₂H₄OC(O)—C(H)═CH₂,

wherein x=6, 8, 10, 12, 14, 16, and 18 in the respective relative amounts of about 3%, 50%, 31%, 10%, 3%, 2% and 1%, said monomer having a weight average molecular weight of 569; (b) 60 g (44 parts by weight) of stearyl methacrylate; (c) 2.5 g (2 parts by weight) 2-hydroxyethylmethacrylate; (d) 2.5 g (2 parts by weight) of poly(oxyethylene)-7-methacrylate, (e) 2.5 g (2 parts by weight) of N-methylol-acrylamide; 0.2 g of dodecyl mercaptan, 25 g hexylene glycol, 6.75 g Tergitol 15-S-20 (Union Carbide, Danbury, Conn.), 0.51 g Ethoquad 18/25 (Akzo-Nobel, McCook, IL), and 200 g of water. The charge was purged with nitrogen at 40° C. for 30 minutes and 0.7 g of “VAZO” 56 WSP initiator (E. I. du Pont de Nemours and Company, Wilmington, Del.) was then added to initiate polymerization and the charge was stirred for 8 hours at 55° C. under nitrogen. The resulting fluoropolymer emulsion weighed 388 g with solids content of 33%.

The carpet was treated with the fluoropolymer emulsion as described above and tested. Results are shown in Table 3 below.

### Example 2

A polyfluoroacrylate emulsion comprised of a polyfluoroacrylate made with greater than 10%, by weight of the polymer, of vinylidene chloride, Zonyl® 7040, available from E. I. du Pont de Nemours and Company, Wilmington, Del., was used to treat the carpet as described above and tested. Results are shown in Table 3 below.

TABLE 3
Cure 280° F. (138° C.)

| | Oil | Water | Motor Oil | Corn Oil |
|---|---|---|---|---|
| | Repellency | Repellency | Repellency | Repellency |
| Example 1 | 6 | 8 | 1, NS | 1, NS |
| Example 2 | 5 | 7 | 1, SLS | 1, SLS |
| Untreated | 0 | 4 | 5, SS | 5, SS |

TABLE 4
Cure 300° F. (149° C.)

| | Oil | Water | Motor Oil | Corn Oil |
|---|---|---|---|---|
| | Repellency | Repellency | Repellency | Repellency |
| Example 1 | 6 | 8 | 1, NS | 1, NS |
| Example 2 | 6+ | 8 | 1, NS | 1, NS |
| Untreated | 0 | 4 | 5, SS | 5, SS |

In the above tests, the composition of Example 1 and Example 2 tested significantly better than the untreated sample. The fluoropolymer of Example 1 containing a 50/50 ratio of the fluoromonomer/alkyl monomer out-performed the fluoropolymer of Example 2 with a higher concentration of the fluoromonomer. The data also shows that excellent performance can be obtained at a lower cure temperature than 300° F.(149° C.), which is important for 3GT carpets.

TABLE 5
Yellowing

| | Degree of yellowing (color) | |
|---|---|---|
| | Initial | After Cure |
| Example 1 | 1 | 2 |
| Example 2 | 1 | 10 |
| Untreated | 1 | 1 |

The sample containing more than 10% vinylidene chloride (Example 2) yellowed much more than the sample of Example 1. The data illustrates that the reduction or exclusion of vinylidene chloride from the fluoropolymer drastically reduces the yellowing effect upon curing. The reduction in color is important especially when dealing with the finishing of white or light colored carpets. This illustrates how versatile these fluoropolymer emulsions can be across many different colors of carpets.

### Comparative Example

A polyfluoroacrylate emulsion comprised of a polyfluoroacrylate made with greater than 10%, by weight of the fluoropolymer, of vinylidene chloride, used commercially on synthetics as a repellent, Zonyl® 8300, available from E. I. du Pont de Nemours and Company, Wilmington, Del., was used to treat carpet as described above and tested. Its performance versus carpets prepared in Examples 1 and 2, and an untreated control, is shown in Tables 6 and 7 below.

TABLE 6
Cure 280° F. (138° C.)

| | Oil | Water | Motor Oil | Corn Oil |
|---|---|---|---|---|
| | Repellency | Repellency | Repellency | Repellency |
| Example 1 | 6 | 8 | 1, NS | 1, NS |
| Example 2 | 5 | 7 | 1, SLS | 1, SLS |
| Comparative | 2 | 4 | 3, SLS | 3, SLS |
| Example | | | | |
| Untreated | 0 | 4 | 5, SS | 5, SS |

TABLE 7
Cure 300° F. (149° C.)

| | Oil | Water | Motor Oil | Corn Oil |
|---|---|---|---|---|
| | Repellency | Repellency | Repellency | Repellency |
| Example 1 | 6 | 8 | 1, NS | 1, NS |
| Example 2 | 6+ | 8 | 1, NS | 1, NS |
| Comparative | 2 | 4 | 3, SLS | 3, SLS |
| Example | | | | |
| Untreated | 0 | 4 | 5, SS | 5, SS |

As shown above, the water repellency and oil repellency ratings were better for the samples of the invention than the comparative sample. At both curing temperatures, the carpets of Examples 1 and 2 had excellent oil and water repellency. The comparative example had slightly better oil repellency than the control (untreated) sample, but it was not nearly as good as the results achieved with the invention. The water repellency of the comparative example was similar to that obtained with the control.

On the scales for motor and corn oil repellency lower numbers indicate better performance. With the example representing the invention (Example 1), the carpets did not wick the oil drops and the carpet was given the highest rating. After the oil drops were removed, no stain remained. In contrast, with the comparative carpet the drops were flat initially giving a rating of 3 and slight staining was observed. The control sample soaked immediately and had severe staining.

While the invention has been described with respect to specific embodiments, it should be understood that they are not intended to be limiting and that many variations and modifications are possible without departing from the scope of the invention.

What is claimed is:

1. A treated poly(trimethylene terephthalate) carpet prepared by a process comprising applying a fluoropolymer emulsion to a poly(trimethylene terephthalate) carpet and curing the fluoropolymer at a temperature of about 250 to about 310° F., the treated poly(trimethylene terephthalate) carpet having an oil repellency rating of at least 4.

2. The treated poly(trimethylene terephthalate) carpet of claim 1 wherein the curing the fluoropolymer is at a temperature of about 260° F. to about 305° F. for about 30 seconds to about 5 minutes.

3. The treated poly(trimethylene terephthalate) carpet of claim 1 herein the curing the fluoropolymer is at a temperature of about 280° F. up to about 300° F. for about 30 seconds to about 3 minutes.

4. The treated poly(trimethylene terephthalate) carpet of claim 1 having a water repellency rating of at least 6.

5. The treated poly(trimethylene terephthalate) carpet of claim 1 having a corn oil stain repellency rating of 2 to 1 and a staining rating slight (SLS) to none (NS).

6. The treated poly(trimethylene terephthalate) carpet of claim 1 having a motor oil stain repellency rating of 2 to 1 and a staining rating slight (SLS) to none (NS).

7. The treated poly(trimethylene terephthalate) carpet of claim 2 having a water repellency rating of at least 6, a corn oil stain repellency rating of 2 to 1, and a staining rating slight (SLS) to none (NS).

8. The treated poly(trimethylene terephthalate) carpet of claim 3 having a water repellency rating of at least 6, a corn oil stain repellency rating of 2 to 1, and a staining rating slight (SLS) to none (NS).

9. A treated poly(trimethylene terephthalate) carpet prepared by a process comprising applying a fluoropolymer emulsion to a poly(trimethylene terephthalate) carpet and curing the fluoropolymer at a temperature of about 250 to about 310° F., the treated poly(trimethylene terephthalate) carpet having an oil repellency rating of at least 4, wherein the fluoropolymer emulsion is prepared by emulsion polymerization of the following monomers in the following weight percentages, based on the total weight of the fluoropolymer:
(a) from about 40% to about 75% of a monomer of formula I:
R_{f}—CH₂CH₂—OC(O)—C(R)═CH₂ (I)
(b) from about 15% to about 55% of a monomer of formula II:
R₂—OC(O)—C(R)═CH₂ (II)
(c) from about 0.5% to about 5% of a monomer of the formula III:
HO—CH₂CH₂—OC(O)—C(R)═CH₂ (III)
(d) from about 1.5% to about 5% of a monomer of the formula IV:
H—(OCH₂CH₂)ₘ—O—C(O)—C(R)═CH₂ (IV)
(e) from about 1% to about 3% of a monomer of the formula V:
HO—CH₂—NH—C(O)—C(R)═CH₂ (V)
(f) from 0% up to about 20% of vinylidene chloride (formula VI) or vinyl acetate (formula VII), or a mixture thereof:
CH₂═CCl₂ (VI)
CH₃—(O)COCH═CH₂ (VI),
wherein R_{f} is a straight or branched-chain perfluoroalkyl group of from 2 to about 20 carbon atoms, each R is independently H or CH₃; R₂ is an alkyl chain from 2 to about 18 carbon atoms; and m is 2 to about 10.

10. The treated poly(trimethylene terephthalate) carpet of claim 9 having a water repellency rating of at least 6.

11. The treated poly(trimethylene terephthalate) carpet of claim 10 having a corn oil stain repellency rating of 2 to 1 and a staining rating slight (SLS) to none (NS).

12. The treated poly(trimethylene terephthalate) carpet of claim 10 having a motor oil stain repellency rating of 2 to 1 and a staining rating slight (SLS) to none (NS).

13. The treated poly(trimethylene terephthalate) carpet of claim 11 wherein the curing the fluoropolymer is at a temperature of about 260° F. to about 305° F. for about 30 seconds to about 5 minutes.

14. The treated poly(trimethylene terephthalate) carpet of claim 11 herein the curing the fluoropolymer is at a temperature of about 280° F. up to about 300° F. for about 30 seconds to about 3 minutes.

15. The treated poly(trimethylene terephthalate) carpet of claim 9 wherein the fluoropolymer emulsion is made by polymerizing the monomers (I)-(VII) in the following percentages by weight:
(a) from about 40% to about 65% of the monomer of formula (I);
(b) from about 15% to about 50% of the monomer of formula (II);
(c) from about 1.5% to about 5% of the monomer of formula (III);
(d) from about 1.5% to about 5% of the monomer of formula (IV);
(e) from about 1.5% to about 3% of the monomer of formula (V); and
(f) from 0% up to about 20% of the monomer of formula (VI) and/or (VII).

16. The treated poly(trimethylene terephthalate) carpet of claim 9 wherein the fluoropolymer emulsion is made by polymerizing the monomers (I)-(VII) in the following percentages by weight:
(a) from about 40% to about 50% of the monomer of formula (I);
(b) from about 40% to about 50% of the monomer of formula (II);
(c) from about 4% to about 5% of the monomer of formula (III);
(d) from about 4% to about 5% of the monomer of formula (IV);
(e) from about 1.5% to about 3% of the monomer of formula (V); and
(f) from 0% up to about 10% of the monomer of formula (VI) and/or (VII).

17. The treated poly(trimethylene terephthalate) carpet of claim 16 wherein the carpet has a yellowing rating of 3 to 1.

18. The treated poly(trimethylene terephthalate) carpet of claim 16 which wherein the fluoropolymer emulsion is made without vinylidene chloride.

19. The treated poly(trimethylene terephthalate) carpet of claim 1 wherein the fluoropolymer emulsion is made by polymerizing the monomers (I)-(VII) in the following percentages by weight:
(a) from about 55% to about 65% of the monomer of formula (I);
(b) from about 15% to about 25% of the monomer of formula (I);
(c) from about 1.5% to about 5% of the monomer of formula (III);
(d) from about 1.5% to about 5% of the monomer of formula (IV);
(e) from about 1.5% to about 3% of the monomer of formula (V); and
(f) from about 10% up to about 20% of the monomer of formula (VI) and/or (VII).

20. The treated poly(trimethylene terephthalate) carpet of claim 9 wherein R_{f} in monomer (a) of formula I is: CF₃CF₂(CF₂)ₓC₂H₄OC(O)—C(H)═CH₂, wherein x=6-18.

21. The treated poly(trimethylene terephthalate) carpet of claim 9 wherein monomer (b) is one or a mixture of alkyl (meth)acrylates having chain lengths of 12 to 18 carbons.

22. The treated poly(trimethylene terephthalate) carpet of claim 9 wherein monomer (c) is hydroxyethyl methacrylate.

23. The treated poly(trimethylene terephthalate) carpet of claim 9 wherein for monomer (d), m is between about 5 and about 10.

24. The treated poly(trimethylene terephthalate) carpet of claim 9 wherein monomer (e) is N-methylol acrylamide or methacrylamide.

25. The treated poly(trimethylene terephthalate) carpet of claim 9 wherein R_{f} in monomer (a) of formula I is: CF₃CF₂(CF₂)ₓC₂H₄OC(O)—C(H)═CH₂, wherein x=6-18; monomer (b) is stearyl (meth)acrylate; monomer (c) is hydroxyethyl methacrylate; in monomer (d), m is between about 5 and about 10; and monomer (e) is N-methylol acrylamide or methacrylamide.

26. The treated poly(trimethylene terephthalate) carpet of claim 9 having a fluorine content of from about 0.05% to about 0.5% weight %, by weight of the face fibers.

27. The treated poly(trimethylene terephthalate) carpet of claim 9 wherein the poly(trimethylene terephthalate) carpet contains at least 70 weight %, by weight of face fibers of the carpet, of tufted poly(trimethylene terephthalate) bulked continuous filament or poly(trimethylene terephthalate) staple fiber yarn, the poly(trimethylene terephthalate) containing at least about 70 mole % or more of poly(trimethylene terephthalate).

28. The treated poly(trimethylene terephthalate) carpet of claim 27 containing at least 98 weight %, by weight of the face fibers of the poly(trimethylene terephthalate) carpet, of the tufted poly(trimethylene terephthalate) bulked continuous filament.

29. The treated poly(trimethylene terephthalate) carpet of claim 28 wherein the poly(trimethylene terephthalate) contains at least about 90 mole % or more of poly(trimethylene terephthalate).

30. The treated poly(trimethylene terephthalate) carpet of claim 29 having a fluorine content of from about 0.05% to about 0.5% weight %, by weight of the face fibers.

31. A process of preparing the treated poly(trimethylene terephthalate) carpet of claim 1 comprising (a) applying the fluoropolymer emulsion to the poly(trimethylene terephthalate) carpet and curing the fluoropolymer at a temperature of about 250 to about 310° F., the treated poly(trimethylene terephthalate) carpet having an oil repellency rating of at least 4.

32. A process of preparing the treated poly(trimethylene terephthalate) carpet of claim 9 comprising (a) applying the fluoropolymer emulsion to the poly(trimethylene terephthalate) carpet and curing the fluoropolymer at a temperature of about 250 to about 310° F., the treated poly(trimethylene terephthalate) carpet having an oil repellency rating of at least 4.

33. The process of claim 31 wherein the fluoropolymer emulsion is an aqueous emulsion comprising 15-35 weight %, by weight of the emulsion, of the fluoropolymer.
